(19) United States
(12) Patent Application Publication
(10) Pub. No.: US 2024/0416312 A1
(43) Pub. Date: Dec. 19, 2024

(54) APPARATUS FOR PREPARING LITHIUM SULFIDE

(71) Applicant: LAKE TECHNOLOGY., LTD, Sejong-si (KR)

(72) Inventors: Seong Hoon JEONG, Cheonan-si (KR); Sang Yun LEE, Sejong-si (KR); Sung Yoon BAEK, Daejeon (KR); Yong Hwan NA, Sejong-si (KR); Taek Seung YANG, Icheon-si (KR); Yik Haeng CHO, Daejeon (KR); Chang Ho SONG, Cheongju-si (KR); Jin Dong KIM, Sejong-si (KR)

(73) Assignee: LAKE TECHNOLOGY., LTD, Sejong-si (KR)

(21) Appl. No.: 18/816,125

(22) Filed: Aug. 27, 2024

Related U.S. Application Data
(63) Continuation of application No. PCT/KR2023/001957, filed on Feb. 10, 2023.

(30) Foreign Application Priority Data
Feb. 28, 2022 (KR) 10-2022-0026246

(51) Int. Cl. B01J 10/00; B01D 53/26; B01J 19/00; B01J 19/26; C01B 17/22

(52) U.S. Cl. CPC B01J 10/002; B01D 53/265; B01J 19/0013; B01J 19/26; C01B 17/22; B01D 2257/80

(57) ABSTRACT

An apparatus for preparing lithium sulfide includes a reaction chamber that has a reaction space for generating lithium sulfide and is provided to move a supplied lithium raw material in a predetermined direction; a lithium raw material supply unit provided to continuously supply the lithium raw material to an upstream side of the reaction chamber in the predetermined direction; a hydrogen sulfide supply unit provided to supply hydrogen sulfide to the reaction chamber; a heating unit; a lithium sulfide recovery unit provided on a downstream side of the reaction chamber in the predetermined direction and provided to recover lithium sulfide that is generated by a reaction between the hydrogen sulfide and the lithium raw material in the reaction chamber; an inert gas supply unit provided to supply an inert gas to the upstream side of the reaction chamber in the predetermined direction; and a moisture removal unit.

### CROSS-REFERENCE TO RELATED APPLICATIONS

This application is a continuation of International Application No. PCT/KR2023/001957 filed on Feb. 10, 2023, which claims priority to Korean Patent Application No. 10-2022-0026246 filed on Feb. 28, 2022, the entire contents of which are herein incorporated by reference.

### TECHNICAL FIELD

The present invention relates to an apparatus for preparing lithium sulfide.

### BACKGROUND ART

Since lithium secondary batteries have high energy density and a long lifespan, they are widely used in electronic devices such as home appliances, laptop computers, and smartphones, and recently, their utilization is greatly increasing as they are installed in electric vehicles (EVs) and hybrid electric vehicles (HEVs).

Lithium-ion secondary batteries, which are mainly used today, have been widely used as the main power source for mobile phones, laptops, and PCs since mass production began in 1991 due to their high energy density and output voltage, but the organic electrolyte provided for the smooth movement of lithium ions carries the risk of explosion in overheating and overcharge conditions, and when there is a source of ignition, it can easily catch fire, and when side reactions occur inside the battery, battery performance and stability may deteriorate due to gas generation.

Accordingly, in order to overcome the shortcomings of lithium-ion secondary batteries, research and development on lithium all-solid-state secondary batteries is being actively conducted. Lithium all-solid-state secondary batteries not only reduce the risk of explosion by using a solid electrolyte instead of a volatile electrolyte, but also have the advantage of dramatically improving the energy density of the battery because lithium metal (Li Metal) or a lithium alloy (Li Alloy) can be used as the negative electrode material.

Today, among the solid electrolyte candidates that can be mounted in all-solid-state batteries, sulfide-based solid electrolytes known to have high ductility and high ionic conductivity are evaluated as suitable for manufacturing high-capacity and large-scale secondary batteries, and lithium sulfide (Li₂S) is evaluated as a key material in the manufacturing process of these sulfide-based solid electrolytes. Various methods for synthesizing lithium sulfide are known, but the most common method is known to be the reaction of metallic lithium, such as lithium hydroxide (LiOH) or lithium carbonate (Li₂CO₃), with hydrogen sulfide (H₂S).

Meanwhile, hydrogen sulfide gas is a highly corrosive gas, and when the hydrogen sulfide gas reacts with metallic lithium in a conventional metal reactor, equipment such as the reactor and various pieces of piping is corroded, requiring frequent repairs and replacements, which reduces the economic feasibility of lithium sulfide mass production.

In addition, when metallic lithium such as lithium hydroxide is reacted with hydrogen sulfide, water vapor is inevitably generated, the water vapor generated at this time not only interferes with the contact between the metallic lithium and hydrogen sulfide, reducing the yield of lithium sulfide, but also reacts with lithium sulfide again to accelerate the reverse reaction into lithium hydroxide, which causes the problem of lowering the purity of the lithium sulfide being produced. In addition, moisture may cause agglomeration between produced lithium sulfide particles, causing quality deterioration.

Accordingly, as a result of researching a method for preparing lithium sulfide with high purity and high yield by using a reaction that produces lithium sulfide by reacting metallic lithium and hydrogen sulfide while effectively suppressing corrosion of the reactor and effectively removing water vapor generated as a reaction product, the inventors have completed the present invention.

### SUMMARY

### Technical Problem

The present invention was proposed to solve the above problems, and is directed to providing an apparatus for preparing lithium sulfide, which may mass-produce lithium sulfide with high purity and high yield by designing a reactor with specific materials and temperature conditions to be suitable for mass production of lithium sulfide with high purity and high yield through the reaction between metallic lithium and hydrogen sulfide, and furthermore, by selectively removing moisture from the gas generated during the reaction to minimize side reactions/reverse reactions.

### Technical Solution

In one example, an apparatus for preparing lithium sulfide includes a reaction chamber that has a reaction space for generating lithium sulfide and is provided to move a supplied lithium raw material in a predetermined direction; a lithium raw material supply unit provided to continuously supply the lithium raw material to an upstream side of the reaction chamber in the predetermined direction; a hydrogen sulfide supply unit provided to supply hydrogen sulfide to the reaction chamber; a heating unit provided to heat the reaction space; a lithium sulfide recovery unit provided on a downstream side of the reaction chamber in the predetermined direction and provided to recover lithium sulfide that is generated by a reaction between the hydrogen sulfide and the lithium raw material in the reaction chamber; an inert gas supply unit provided to supply an inert gas to the upstream side of the reaction chamber in the predetermined direction; and a moisture removal unit provided on the downstream side of the reaction chamber in the predetermined direction to recover gas discharged from the reaction chamber, remove water vapor from the gas, and then supply the gas back to the upstream side of the reaction chamber in the predetermined direction, wherein the hydrogen sulfide supply unit is a hydrogen sulfide reactor that synthesizes hydrogen sulfide by using liquid sulfur that is sprayed from a liquid sulfur spray pipe and hydrogen gas.

In another example, the moisture removal unit may include a liquefaction cooling unit that primarily cools the gas recovered from the reaction chamber and selectively removes only moisture from the gas.

In still another example, the moisture removal unit may include a sublimation cooling unit that secondarily cools the gas recovered from the reaction chamber and selectively removes only moisture from the gas.

In yet another example, the sublimation cooling unit may include a plurality of cooling chambers and a control unit that controls the sublimation cooling unit, and when the recovered gas is transferred to one or more preset cooling chambers among the plurality of cooling chambers, the control unit may control secondary cooling to be performed in the cooling chamber to which the recovered gas is transferred.

In yet another example, after the cooling chamber to which the recovered gas is transferred is cooled for a predetermined period of time, the control unit may control the recovered gas to be transferred to another cooling chamber, and the cooling chamber that has been cooled for the predetermined period of time may be heated to liquefy and remove ice sublimated by cooling.

In yet another example, the sublimation cooling unit may include a plurality of branch lines for transferring the recovered gas to the plurality of cooling chambers, and a valve installed in the branch lines to open and close each branch line, and the control unit may be configured to determine the cooling chamber to which the recovered gas is transferred by controlling the valves.

In yet another example, the sublimation cooling unit may have a main body provided to be rotatable about an axis parallel to the direction in which the recovered gas is transferred, the plurality of cooling chambers may be formed to pass through the main body along a direction parallel to the axis, and at least one cooling chamber is provided to communicate with a recovery line, which is a line through which the recovered gas is transferred, and a resupply line to allow the recovered gas to be resupplied to the reaction chamber, and the control unit may control the cooling chamber performing cooling to communicate with the recovery line and the resupply line by rotating the main body about the axis.

In yet another example, after the cooling chamber to which the recovered gas is transferred is cooled for a predetermined period of time, the control unit may rotate the main body about the axis to control the recovery line to communicate with another cooling chamber scheduled for a cooling operation, and the cooling chamber that has been cooled for the predetermined period of time may be heated to liquefy and remove ice sublimated by cooling.

In yet another example, the apparatus may further include an inert gas discharge line connected to the reaction chamber for discharging the inert gas in the reaction chamber, and the inert gas discharge line may be disposed upstream in the predetermined direction from the hydrogen sulfide supply location where the hydrogen sulfide supply unit supplies hydrogen sulfide into the reaction chamber.

In yet another example, the apparatus may further include a partition plate installed in the reaction chamber and extending along a direction crossing the predetermined direction, and, the partition plate may be installed between the hydrogen sulfide supply location and the inert gas discharge line.

In yet another example, the partition plate may be provided on the upper side of the reaction chamber adjacent to the inert gas discharge line, and is provided on the inner side of the reaction chamber to provide a space for fluid to flow.

In yet another example, the hydrogen sulfide reactor may include a hydrogen sulfide reaction chamber having a hollow hydrogen sulfide reaction space and a hydrogen sulfide outlet for discharging hydrogen sulfide synthesized in the hydrogen sulfide reaction space; the liquid sulfur spray pipe configured to recover liquid sulfur accommodated in the hydrogen sulfide reaction chamber and spray it into the hydrogen sulfide reaction space; a liquid sulfur heating device configured to heat the liquid sulfur; a hydrogen gas supply pipe configured to supply hydrogen gas to the hydrogen sulfide reaction space below the position where the liquid sulfur is sprayed from the liquid sulfur spray pipe; and a flow path change member that changes a flow path to be longer than a straight path so that hydrogen gas, sulfur gas generated by vaporizing the liquid sulfur, and hydrogen sulfide synthesized by the reaction of the hydrogen gas and the sulfur gas do not flow in the straight path toward the hydrogen sulfide outlet.

In yet another example, the flow path change member may include a plate extending along a direction crossing the straight path and a first partition wall member having a first outer wall extending from the plate to form a space in which the liquid sulfur and the hydrogen gas are supplied, and the first partition wall member may be disposed to be spaced apart from the hydrogen sulfide reaction chamber so that a first flow path is formed between an outer surface of the first outer wall and an inner surface of the hydrogen sulfide reaction chamber.

In yet another example, the flow path change member may further include a second partition wall member having a second outer wall formed in a pillar shape with both sides open, the liquid sulfur and the hydrogen gas may be supplied to the inner space of the second outer wall, and the second partition wall member may be disposed to be spaced apart from the first partition wall member so that a second flow path is formed between the second partition wall member and the first partition wall member.

In yet another example, the flow path change member may include at least one flow path forming plate extending along a direction crossing the straight path, and the flow path forming plate has one end coupled to the inner surface of the hydrogen sulfide reaction chamber, and the other end extending to be spaced apart from the inner surface of the hydrogen sulfide reaction chamber to form a space for fluid to flow between the other end and the inner surface of the hydrogen sulfide reaction chamber.

In yet another example, the flow path changing member may include a plurality of flow path forming plates, and the plurality of flow path forming plates may be disposed so that the other ends of adjacent flow path forming plates are positioned in opposite directions.

### Advantageous Effects

According to the present invention, when lithium sulfide is produced through a reaction between metallic lithium and hydrogen sulfide, corrosion of the reactor can be minimized, preventing frequent repairs or replacements of equipment, including the reactor and piping, thereby improving the economic efficiency of the process.

In addition, water vapor (moisture), which is a by-product of the reaction, is effectively removed, thus preventing the reverse reaction to lithium hydroxide, promoting the forward reaction, and preventing agglomeration between lithium sulfide particles, so that high-quality lithium sulfide can be mass-produced with high purity and high yield.

In addition, by preparing hydrogen sulfide by finely spraying heated liquid sulfur and bringing it into contact with hydrogen gas, the hydrogen sulfide reactor can allow the reaction heat generated during the reaction to be absorbed as the heat of vaporization of the finely sprayed liquid sulfur particles or to be absorbed into the finely sprayed liquid sulfur particles. Accordingly, the temperature inside the hydrogen sulfide reaction chamber can be prevented from excessively rising, and the generation of by-products such as hydrogen polysulfide (H₂Sₓ) can be minimized.

In addition, since the length of the path through which sulfur gas and hydrogen gas flow is increased by the flow path change member provided in the hydrogen sulfide reaction chamber, the hydrogen sulfide conversion rate can be maximized, and hydrogen sulfide can be produced with high yield and high purity by increasing the contact area and contact time between liquid sulfur (sulfur gas) and hydrogen gas.

### DESCRIPTION OF DRAWINGS

FIG. 1 is a schematic diagram showing an apparatus for preparing lithium sulfide according to one embodiment of the present invention.

FIG. 2 is a schematic diagram showing a hydrogen sulfide reactor according to one embodiment of the present invention.

FIG. 3 is a horizontal cross-sectional view of a hydrogen sulfide reaction chamber for illustrating the arrangement structure of hydrogen gas supply pipes.

FIG. 4 is a cross-sectional view showing the internal structure of a hydrogen sulfide reaction chamber.

FIG. 5 is a plan view of a cover plate.

FIG. 6 is a schematic diagram showing a hydrogen sulfide reactor according to another embodiment of the present invention.

FIG. 7 is a schematic diagram showing a moisture removal unit according to one embodiment of the present invention.

FIG. 8 is a perspective view showing a sublimation cooling unit according to one embodiment of the present invention.

FIG. 9 is a perspective view showing a sublimation cooling unit according to another embodiment of the present invention.

FIG. 10 is a front view showing a sublimation cooling unit according to still another embodiment of the present invention.

### DETAILED DESCRIPTION

Hereinafter, embodiments of the present invention will be described in detail with reference to the accompanying drawings. In assigning reference numerals to components of each drawing, it should be noted that the same reference numerals are assigned to the same components as much as possible even when the components are illustrated in different drawings. In addition, in describing the embodiments of the present invention, when it is determined that a detailed description of a related known configuration or function hinders understanding of the embodiments of the present invention, the detailed description will be omitted.

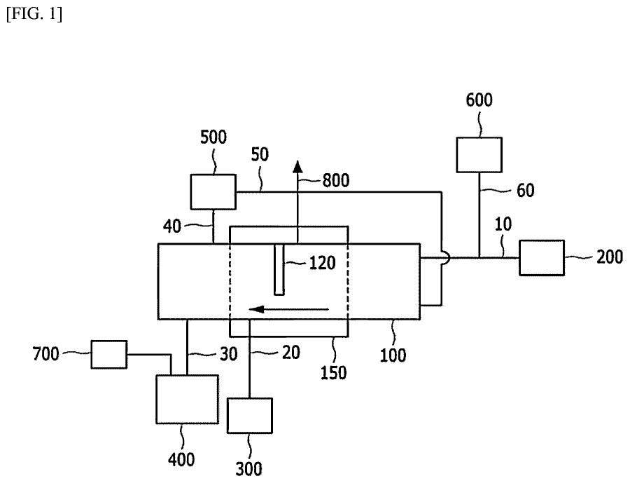

FIG. 1 is a schematic diagram showing an apparatus for preparing lithium sulfide according to one embodiment of the present invention. Hereinafter, an apparatus for preparing lithium sulfide according to one embodiment of the present invention will be described with reference to FIG. 1.

The apparatus for preparing lithium sulfide according to one embodiment of the present invention includes a reaction chamber 100, a heating unit 150, a lithium raw material supply unit 200, a hydrogen sulfide supply unit 300, a lithium sulfide recovery unit 400, a moisture removal unit 500, and an inert gas supply unit 600. Meanwhile, although not shown, a separately provided supply means such as a circulation pump may be used as a means to promote material movement between each component within the production apparatus.

The reaction chamber 100 is a chamber having a reaction space for preparing lithium sulfide. Lithium raw materials and hydrogen sulfide react in the reaction space to synthesize lithium sulfide. The reaction chamber 100 is configured to move the supplied lithium raw material in a predetermined direction. For example, as shown in FIG. 1, the reaction chamber may be configured so that the lithium raw material supplied to the right side of the reaction chamber 100 moves to the left side. The method and direction of moving the lithium raw material are not particularly limited. For example, a conveyor belt may be installed in the reaction chamber 100, and the bottom surface of the reaction chamber 100 may be inclined so that the lithium raw material is moved by gravity.

Meanwhile, an agitating member (not shown) may be further provided in the reaction chamber to promote the reaction, and for example, a rotating disk, a rotor, a propeller, and the like may be employed, but the present invention is not particularly limited.

The lithium raw material supply unit 200 is provided to continuously supply a lithium raw material to the reaction chamber 100. The lithium raw material supply unit 200 supplies the lithium raw material to the upstream side of the reaction chamber 100 in a predetermined direction in which the lithium raw material is moved through a lithium raw material supply line 10. Here, the upstream side in a predetermined direction may refer to the upstream side of the area of the reaction space heated by the heating unit 150, which will be described later. The size or shape of the lithium raw material supply unit 200 is not particularly limited. For example, the lithium raw material supply unit 200 may be a hopper.

The lithium raw material supply unit 200 may supply lithium hydroxide (LiOH) or lithium carbonate (Li₂CO₃), specifically lithium hydroxide, as a lithium raw material. Lithium hydroxide supplied to the reaction chamber 100 may react with hydrogen sulfide supplied by the hydrogen sulfide supply unit 300, which will be described later, to produce lithium sulfide as shown in the following formula. That is, it can be seen that when lithium hydroxide and hydrogen sulfide react, water is produced as a by-product.

2LiOH+H₂S→Li₂S+2H₂O

In addition, the supplied lithium raw material may have a particle size of 1 mm or less. Therefore, high purity lithium sulfide may be produced by increasing the reaction area with hydrogen sulfide.

The heating unit 150 is configured to heat the reaction space. The method by which the heating unit 150 heats the reaction space is not particularly limited. For example, the heating unit 150 may be a heater, a heating wire, or an infrared heater mounted on the outer surface of the reaction chamber 100.

In addition, the heating unit 150 may raise the temperature of the reaction space to 160° C. or higher and less than 300° C. In order for the lithium raw material and hydrogen sulfide to react smoothly, the lithium raw material (lithium hydroxide) needs to be sufficiently heated. In addition, as described above, water (H₂O) is produced as a by-product by the reaction between lithium hydroxide and hydrogen sulfide, and when water is present in liquid form, there is a risk that water may flow between lithium hydroxide particles and reduce the area of lithium hydroxide that reacts with hydrogen sulfide. Therefore, high purity lithium sulfide may be obtained by heating the temperature of the reaction space to 160° C. or higher and evaporating water.

Meanwhile, the higher the temperature of the reaction space, the more likely it is that the reaction between lithium hydroxide and hydrogen sulfide will be promoted. However, since the melting point of lithium hydroxide is 445° C., it is preferable that the temperature of the reaction space does not exceed 445° C.

In addition, as the temperature of the reaction space increases, the risk of corrosion of the inner surface of the reaction chamber 100 due to hydrogen sulfide increases. Therefore, the reaction chamber 100 may be manufactured from a material with strong heat resistance and corrosion resistance. For example, the reaction chamber 100 may be made of Hastelloy X or Stainless Steel 310 (SUS 310). In addition, the heating unit 150 may raise the temperature of the reaction space to less than 300° C. Accordingly, frequent repair or replacement of equipment such as the reaction chamber 100 and piping may be prevented, and at the same time, high purity lithium sulfide may be obtained by sufficiently promoting the reaction between hydrogen sulfide and lithium raw materials.

The hydrogen sulfide supply unit 300 is provided to supply hydrogen sulfide to the reaction chamber 100. Specifically, the hydrogen sulfide supply unit 300 is provided on a downstream side of the location where the lithium raw material is supplied and may supply hydrogen sulfide into the reaction chamber. Therefore, it is possible to suppress hydrogen sulfide from flowing toward the lithium raw material supply line 10. In addition, when the hydrogen sulfide supply unit is provided at the above location, the unreacted lithium raw materials downstream of the reaction chamber may react with hydrogen sulfide due to the high concentration of hydrogen sulfide supplied directly from the downstream side of the reaction chamber, while the hydrogen sulfide supplied back to the reaction chamber through the resupply line, which will be described later, moves from the upstream side of the reaction chamber to the downstream side and comes into contact with the lithium raw material supplied from the lithium raw material supply unit to secure sufficient reaction time, thereby preparing high purity lithium sulfide. Furthermore, since the supplied hydrogen sulfide is almost 100% consumed near the partition plate, which will be described later, there is an effect of minimizing the inclusion of hydrogen sulfide in the gas discharged through an inert gas discharge line.

Meanwhile, the method by which the hydrogen sulfide supply unit 300 generates or supplies hydrogen sulfide is not particularly limited. Hydrogen sulfide is an industrially important intermediate for synthesizing various sulfur-containing compounds, and is widely used as a raw material for manufacturing refined chemical products such as dyes, pesticides, plastics, pharmaceuticals, cosmetics, and sulfide-based solid-state batteries, and as a starting material for preparing metal sulfides. In addition, a catalytic reaction and a non-catalytic reaction are known as methods for preparing hydrogen sulfide from sulfur and hydrogen.

The catalytic reaction is a method of preparing hydrogen sulfide by reacting sulfur gas and hydrogen gas in a reaction tube filled with a catalyst, and the reaction heat is removed by circulating a heat medium outside the reaction tube. This catalytic reaction is disclosed in Japanese Patent Application No. 2010-515658.

At this time, in the catalytic reaction of hydrogen sulfide, when the concentration of sulfur is high, the temperature rises significantly due to the heat of reaction, and there is a problem that the catalyst may be abnormally heated and deteriorated. In addition, in order to increase the hydrogen sulfide conversion rate, the reaction temperature should be increased, but as the reaction temperature increases, a problem arises in that impurities such as hydrogen polysulfide (H₂Sₓ), which is a side reaction product, also increase.

Meanwhile, the non-catalytic reaction is a method of preparing hydrogen sulfide by supplying hydrogen gas into liquid sulfur and allowing the sulfur gas generated by evaporation of liquid sulfur to react with hydrogen gas.

Since the reaction heat generated when hydrogen gas and sulfur gas react is recovered in the process of contact with liquid sulfur, there is an advantage that the reaction temperature does not become excessively high, but there is a disadvantage that the contact area between liquid sulfur and hydrogen gas is small and the contact time is relatively short, so the hydrogen sulfide conversion rate is low.

The hydrogen sulfide supply unit 300 according to one embodiment of the present invention may be a hydrogen sulfide reactor that synthesizes hydrogen sulfide using liquid sulfur and hydrogen gas sprayed from a liquid sulfur spray pipe 304, which will be described later.

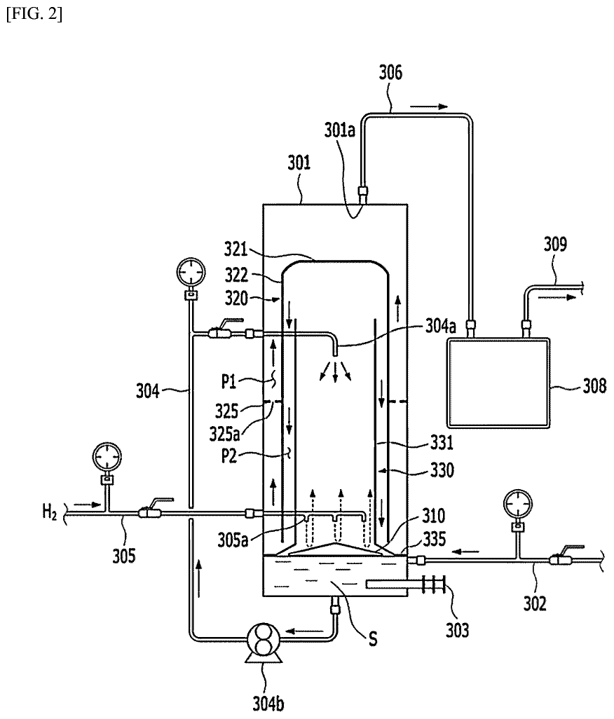

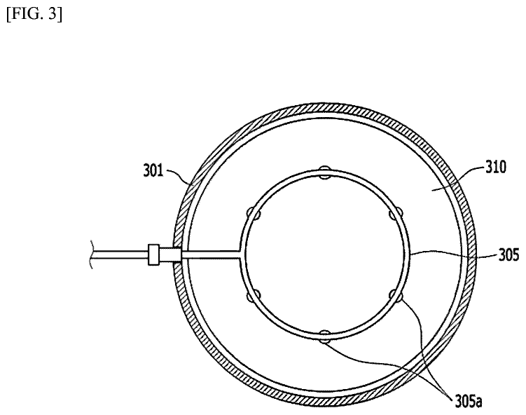

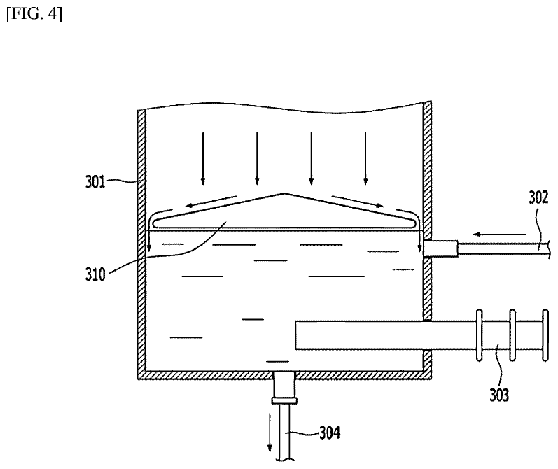

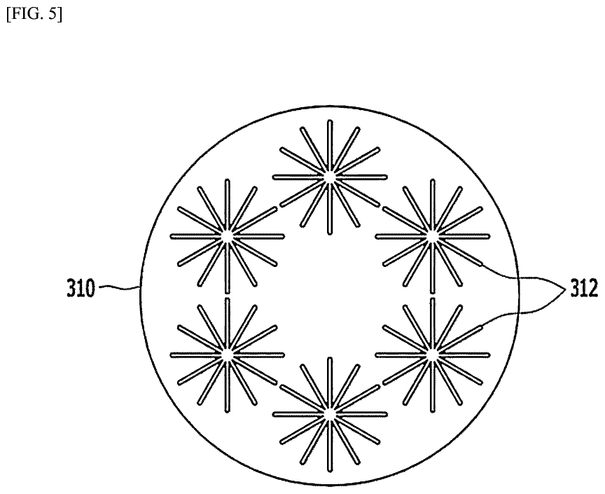

FIG. 2 is a schematic diagram showing a hydrogen sulfide reactor according to one embodiment of the present invention. FIG. 3 is a horizontal cross-sectional view of a hydrogen sulfide reaction chamber for illustrating the arrangement structure of hydrogen gas supply pipes. FIG. 4 is a cross-sectional view showing the internal structure of a hydrogen sulfide reaction chamber. FIG. 5 is a plan view of a cover plate. Hereinafter, with reference to FIGS. 2 to 5, a hydrogen sulfide reactor according to one embodiment of the present invention will be described.

The hydrogen sulfide reactor 300 for synthesizing hydrogen sulfide according to the present invention includes a hydrogen sulfide reaction chamber 301, flow path change members 320 and 330, a liquid sulfur heating device 303, a liquid sulfur spray pipe 304, and a hydrogen gas supply pipe 305.

First, the hydrogen sulfide reaction chamber 301 is a chamber having a hollow reaction space where synthesis into hydrogen sulfide takes place. Hydrogen sulfide is synthesized by the reaction between sulfur gas generated by vaporization from liquid sulfur and hydrogen gas supplied to the reaction space. The hydrogen sulfide reaction chamber 301 has a hydrogen sulfide outlet 301a through which hydrogen sulfide synthesized in the reaction space is discharged. Additionally, other components such as a liquid sulfur supply pipe 302, a liquid sulfur heating device 303, a liquid sulfur spray pipe 304, a hydrogen gas supply pipe 305, and a discharge pipe 306 are connected to the hydrogen sulfide reaction chamber 301. The shape of the hydrogen sulfide reaction chamber 301 is not particularly limited.

Liquid sulfur may be stored in the hydrogen sulfide reaction chamber 301. For example, liquid sulfur may be supplied into the hydrogen sulfide reaction chamber 301 through the liquid sulfur supply pipe 302. In addition, the liquid sulfur spray pipe 304 is configured to recover the liquid sulfur accommodated in the hydrogen sulfide reaction chamber 301 and spray it back into the reaction space as ultrafine particles.

More specifically, one end of the liquid sulfur spray pipe 304 is connected to the portion in the hydrogen sulfide reaction chamber 301 where liquid sulfur is stored, and the other end extends through the hydrogen sulfide reaction chamber 301 into the reaction space. For example, one end of the liquid sulfur spray pipe 304 may be connected to the bottom surface of the hydrogen sulfide reaction chamber 301 to facilitate the recovery of liquid sulfur. In addition, a liquid sulfur spray nozzle 304a configured to spray liquid sulfur is provided at the other end of the liquid sulfur spray pipe 304, and the recovered liquid sulfur is sprayed into the reaction space through the liquid sulfur spray nozzle 304a.

A plurality of liquid sulfur spray nozzles 304a may be provided. For example, a plurality of liquid sulfur spray nozzles 304a may be formed at the other end of the liquid sulfur spray pipe 304. Alternatively, a plurality of branch lines may be provided from the liquid sulfur spray pipe 304 so that liquid sulfur may be sprayed at different heights in the reaction space, and a liquid sulfur spray nozzle 304a may be provided at the end of each branch line.

Meanwhile, in order to synthesize hydrogen sulfide using liquid sulfur, it is necessary to vaporize liquid sulfur into sulfur gas, which is then allowed to react with hydrogen gas. In addition, by appropriately adjusting the particle size of the liquid sulfur sprayed from the liquid sulfur spray pipe 304, pressure, and temperature, vaporization of liquid sulfur into sulfur gas may be promoted.

To this end, the liquid sulfur spray nozzle 304a may be provided so that the particle size of the liquid sulfur being sprayed is 10 μm to 1000 μm, or 10 μm to 500 μm. Accordingly, the sprayed liquid sulfur is easily vaporized into sulfur gas, and the contact area with hydrogen gas also increases, so the hydrogen sulfide conversion rate may be improved.

In addition, a pump 304b is provided in the liquid sulfur spray pipe 304, and the pump 304b may be controlled by a controller (not shown) so that the liquid sulfur sprayed from the liquid sulfur spray pipe 304 is compressed to 1 bar to 10 bar or 2 bar to 5 bar. In addition, the pump 304b may be controlled so that the flow rate of liquid sulfur sprayed from the liquid sulfur spray pipe 304 is 100 l/h to 10000 l/h, or 500 l/h to 3000 l/h.

In addition, the liquid sulfur heating device 303 is configured to heat liquid sulfur. For example, the liquid sulfur heating device 303 may be disposed within the hydrogen sulfide reaction chamber 301 to heat the liquid sulfur stored in the hydrogen sulfide reaction chamber 301. Alternatively, the liquid sulfur heating device 303 may be installed in the middle of the liquid sulfur spray pipe 304 and configured to heat the liquid sulfur flowing along the liquid sulfur spray pipe 304.

At this time, the liquid sulfur heating device 303 is controlled to heat the liquid sulfur sprayed from the liquid sulfur spray pipe 304 to 300° C. or higher and 600° C. or lower. Alternatively, liquid sulfur may be heated to above 350° C. and below 500° C. Therefore, liquid sulfur sprayed through the liquid sulfur spray pipe 304 may be smoothly vaporized into sulfur gas, and may be easily converted into hydrogen sulfide by reacting with hydrogen gas, which will be described later.

The hydrogen gas supply pipe 305 is configured to supply hydrogen gas to the reaction space below the position where liquid sulfur is sprayed from the liquid sulfur spray pipe 304. That is, hydrogen gas is supplied below liquid sulfur. The supplied hydrogen gas flows upward and reacts with the sulfur gas generated by vaporizing liquid sulfur to synthesize hydrogen sulfide.

The hydrogen gas supply pipe 305 has a hydrogen gas supply nozzle 305a configured to spray hydrogen gas. Referring to FIG. 3, a plurality of hydrogen gas supply nozzles 305a may be provided. For example, a plurality of hydrogen gas supply nozzles 305a may be disposed at equal intervals along the circumferential direction of the circle to diffuse uniformly within the reaction space.

In addition, the hydrogen gas supply nozzle 305a may be formed to face downward.

Specifically, hydrogen gas may be supplied downward based on the horizontal direction, which is a direction perpendicular to the vertical direction. Therefore, compared to the case where hydrogen gas is supplied directly toward the liquid sulfur spray nozzle 304a, the residence time of hydrogen gas in the reaction space may be improved, and the reaction time with the sulfur gas may be improved.

Meanwhile, when hydrogen gas is supplied toward liquid sulfur stored in the hydrogen sulfide reaction chamber 301 and comes into direct contact with liquid sulfur, the hydrogen gas may not diffuse upward, so the hydrogen sulfide conversion rate may be lowered. In addition, there is a risk that liquid sulfur may scatter due to the pressure of the supplied hydrogen gas and contaminate the hydrogen gas supply nozzle 305a. Therefore, a cover plate 310 may be provided in the hydrogen sulfide reaction chamber 301 to cover the space accommodating liquid sulfur from above.

By providing the cover plate 310, it is possible to prevent the supplied hydrogen gas from directly contacting the liquid sulfur and also obtain an effect of the hydrogen gas being heated by receiving heat from the heated liquid sulfur.

In addition, referring to FIGS. 3 and 5, a radial flow path 312 may be formed on the upper surface of the cover plate 310, and when viewed from the top of the hydrogen sulfide reaction chamber 301, the radial flow path 312 may have a groove shape extending radially from a position corresponding to the position where the hydrogen gas supply nozzle 305a is disposed. Therefore, the supplied hydrogen gas may receive more heat through the cover plate 310 while being distributed along the radial flow path 312, and the hydrogen sulfide conversion rate may be further improved.

In addition, referring to FIG. 4, the cover plate 310 may be formed so that its height decreases as its upper surface faces the inner surface of the hydrogen sulfide reaction chamber 301. That is, the upper surface of the cover plate 310 may be formed to be inclined. In addition, the cover plate 310 may be disposed to be spaced apart from the inner surface of the hydrogen sulfide reaction chamber 301. Therefore, liquid sulfur that has not yet been vaporized may flow down along the cover plate 310 and then be stored again in the hydrogen sulfide reaction chamber 301.

In this way, liquid sulfur (sulfur gas) and hydrogen gas supplied into the hydrogen sulfide reaction chamber 301 diffuse within the reaction space to synthesize hydrogen sulfide, and the synthesized hydrogen sulfide is discharged to the outside through the hydrogen sulfide outlet 301a provided in the hydrogen sulfide reaction chamber 301. A discharge pipe 306 for discharging hydrogen sulfide to the outside of the hydrogen sulfide reaction chamber 301 is connected to the hydrogen sulfide outlet 301a, the discharged hydrogen sulfide may be delivered to a condenser 308, undergo a condensation process, and then discharged through a discharge pipe 309 and supplied to the reaction chamber 100 through a hydrogen sulfide supply line 20 (see FIG. 1). Liquid sulfur generated during the condensation process may return to the hydrogen sulfide reaction chamber 301.

However, when hydrogen gas and sulfur gas are supplied to the reaction space and then flow in a straight path toward the hydrogen sulfide outlet 301a, there is a risk that the hydrogen sulfide conversion rate will be low due to insufficient time for the hydrogen gas and sulfur gas to react. Therefore, the present invention includes flow path change members 320 and 330 that change the flow path of hydrogen gas, sulfur gas, and hydrogen sulfide to be longer than the straight path so that they do not flow in the straight path toward the hydrogen sulfide outlet 301a. Referring again to FIG. 2, the flow path change members may include a first partition wall member 320. The first partition wall member 320 has a plate 321 extending along a direction crossing a straight path, and a first outer wall 322 extending from the plate 321. The first outer wall 322 extends from the plate 321 to form a space in which liquid sulfur and hydrogen gas are supplied. At this time, the first partition wall member 320 may be disposed to be spaced apart from the hydrogen sulfide reaction chamber 301 so that a first flow path P1 is formed between the outer surface of the first outer wall 322 and the inner surface of the hydrogen sulfide reaction chamber 301.

Therefore, the supplied liquid sulfur (sulfur gas) and hydrogen gas are prevented from being discharged directly to the hydrogen sulfide outlet 301a by the plate 321, and at the same time, diffuse along the first outer wall 322 in the opposite direction of the hydrogen sulfide outlet 301a. Since the side of the first outer wall 322 opposite the plate 321 is open, the supplied gas flows toward the hydrogen sulfide outlet 301a along the first flow path P1. That is, the hydrogen sulfide conversion rate may be improved by increasing the contact time between hydrogen gas and sulfur gas. Conventionally, a separate hydrogenation catalyst reaction column was provided to further react unreacted hydrogen gas and sulfur gas, but the present invention can obtain high purity hydrogen sulfide at a sufficient conversion rate even without a separate catalyst reaction column.

Meanwhile, since the density of hydrogen is 0.08988 g/L at standard conditions (STP: 0° C., 1 atm) and the density of hydrogen sulfide is 1.539 g/L at standard conditions (STP), hydrogen that has not yet been converted to hydrogen sulfide flows upward to the top of the reactor due to the difference in specific gravity, and hydrogen sulfide flows downward toward the outlet along the first flow path, and at this time, hydrogen whose rise is restricted by the extended plate 321 stays near the plate, reacts with sulfur gas, is converted to hydrogen sulfide, and then flows downward toward the outlet, so the hydrogen sulfide conversion rate may be further improved.

Meanwhile, the first partition wall member 320 has a first flange 325 configured to fix the first outer wall 322 to the inner surface of the hydrogen sulfide reaction chamber 301. The first flange 325 extends from the outer surface of the first outer wall 322 and is coupled to the inner surface of the hydrogen sulfide reaction chamber 301. A first through hole 325a is formed in the first flange 325. Therefore, the fluid flowing along the first flow path P1 may flow to the hydrogen sulfide outlet 301a through the first through hole 325a.

The flow path change members may further include a second partition wall member 330. The second partition wall member 330 has a second outer wall 331 formed in a pillar shape with both sides open. In this case, liquid sulfur and hydrogen gas are supplied to the inner space of the second outer wall 331. In addition, the second partition wall member 330 is disposed to be spaced apart from the first partition wall member 320 so that a second flow path P2 is formed between the second partition wall member 330 and the first partition wall member 320.

Therefore, after flowing along the second outer wall 331 toward the upper opening of the second outer wall 331, the supplied liquid sulfur and hydrogen gas flow in the opposite direction of the hydrogen sulfide outlet 301a along the second flow path P2, and then flow toward the hydrogen sulfide outlet 301a along the first flow path P1, so the contact time between unreacted hydrogen gas and sulfur gas increases, and additional reaction occurs between hydrogen gas and sulfur gas while passing through the flow paths, thereby further improving the hydrogen sulfide conversion rate.

In addition, the second partition wall member 330 has a second flange 335 configured to fix the second outer wall 331 to the inner surface of the hydrogen sulfide reaction chamber 301. The second flange 335 extends from the outer surface of the second outer wall 331 and is coupled to the inner surface of the hydrogen sulfide reaction chamber 301. Alternatively, the second flange 335 may also be provided between the outer surface of the second outer wall 331 and the inner surface of the first outer wall 322. A second through hole (not shown) may also be formed in the second flange 335.

In this way, according to the present invention, since the liquid sulfur sprayed from the liquid sulfur spray pipe 304 is sprayed under conditions in which it is easy to vaporize into sulfur gas, the reaction heat generated when hydrogen sulfide is synthesized is absorbed as the heat of vaporization of liquid sulfur, or may be absorbed into liquid sulfur particles. Accordingly, the temperature inside the hydrogen sulfide reaction chamber 301 may be prevented from excessively rising, and the generation of by-products such as hydrogen polysulfide may be minimized, while promoting the conversion to hydrogen sulfide.

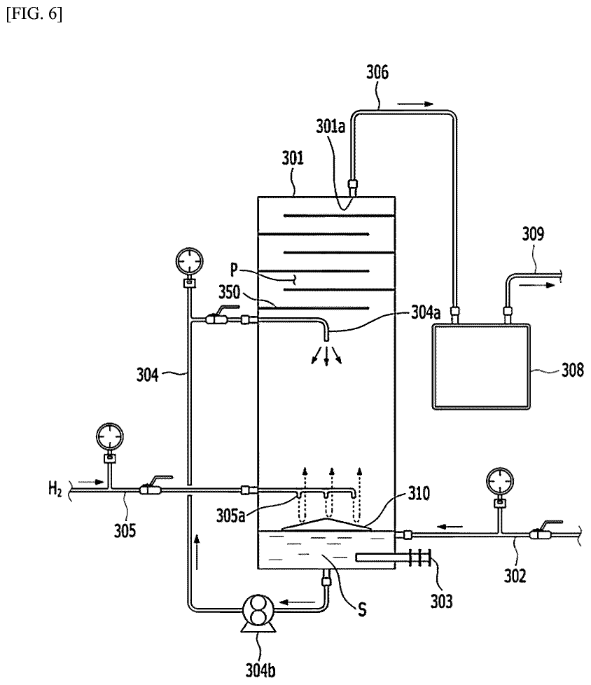

In addition, the present invention includes a flow path change member to make the flow path of the sulfur gas and hydrogen gas toward the outlet 301a longer than the straight path, so the contact area and contact time of the finely sprayed liquid sulfur and vaporized sulfur gas and hydrogen gas can be increased. Therefore, conventionally, a hydrogenation catalyst reaction column for an additional reaction was installed outside the hydrogen sulfide reaction chamber 301 to re-react the unreacted hydrogen gas and sulfur gas, but the present invention can maximize the hydrogen sulfide conversion rate without a separate catalyst reaction column, and for example, high purity hydrogen sulfide may be produced with a high yield of about 99.6% or more. FIG. 6 is a schematic diagram showing a hydrogen sulfide reactor according to another embodiment of the present invention. Hereinafter, a hydrogen sulfide reactor according to another embodiment of the present invention will be described with reference to FIG. 6. The hydrogen sulfide reactor according to this embodiment is different from the hydrogen sulfide reactor according to the above-described embodiment in the shape of the flow path forming member. For components that are the same as or correspond to the above-described embodiments, the same or corresponding reference numbers are assigned and detailed descriptions are omitted.

The flow path forming member according to this embodiment has a flow path forming plate 350 extending along a direction crossing a straight path. One end of the flow path forming plate 350 is coupled to the inner surface of the hydrogen sulfide reaction chamber 301, and the other end extends to be spaced apart from the inner surface of the hydrogen sulfide reaction chamber 301. Accordingly, a space for fluid to flow is formed between the other end of the flow path forming plate 350 and the inner surface of the hydrogen sulfide reaction chamber 301. Therefore, the straight path of the hydrogen gas and the sulfur gas toward the hydrogen sulfide outlet 301a may be blocked by the flow path forming plate 350 to increase the reaction time between gases.

The flow path forming plate 350 may be disposed above the liquid sulfur supply pipe 302. Accordingly, a sufficient reaction time may be secured by increasing the length of the path until the gas is discharged from the hydrogen sulfide outlet 301a without preventing the supplied hydrogen gas from contacting the sulfur gas. As a result, the contact time between unreacted hydrogen gas and sulfur gas increases, and additional reaction occurs between hydrogen gas and sulfur gas while passing through the flow path, thereby further improving the hydrogen sulfide conversion rate.

In addition, a plurality of flow path forming plates 350 may be provided. In this case, a flow path P for fluid to flow is provided between adjacent flow path forming plates 350. In addition, the plurality of flow path forming plates 350 are disposed so that other ends of adjacent flow path forming plates 350 are positioned in opposite directions. Therefore, the length of the path through which hydrogen gas and sulfur gas flow along the plurality of flow path forming plates 350 may be further increased.

Furthermore, a protrusion protruding in a vertical direction parallel to the straight path may be formed at the other extended end of the flow path forming plate. In the case of having the protrusion configuration, when hydrogen gas, sulfur gas, and hydrogen sulfide gas move along the flow path P, since the movement of relatively low-density hydrogen gas is delayed by the protrusion among the fluids, this has the effect of increasing the time for hydrogen gas to react with sulfur gas within the reactor, and as a result, the hydrogen sulfide conversion rate can be improved.

Referring again to FIG. 1, the lithium sulfide recovery unit 400 is provided to recover lithium sulfide generated by the reaction between hydrogen sulfide and lithium raw materials in the reaction chamber 100 through a lithium sulfide recovery line 30. The lithium sulfide recovery unit 400 is provided on the downstream side of the reaction chamber 100 in a predetermined direction. Here, the downstream side in a predetermined direction may mean the downstream side of the area of the reaction space heated by the heating unit 150. The structure of the lithium sulfide recovery unit 400 is not particularly limited. For example, the structure may be a chamber for collecting lithium sulfide.

The inert gas supply unit 600 is configured to supply an inert gas to the upstream side of the reaction chamber 100 in a predetermined direction. The inert gas supplied through an inert gas supply line 60 may prevent the gas in the reaction chamber 100 from flowing back into the lithium raw material supply line 10. The inert gas supply line 60 may be connected to the lithium raw material supply line 10 or may be connected to the reaction chamber 100.

In addition, when the inert gas supply line 60 is directly connected to the reaction chamber 100, the inert gas supply line 60 may be disposed to face a position within the reaction chamber 100 where lithium raw materials are supplied. Therefore, the inert gas may also serve to promote the reaction with hydrogen sulfide by stirring the lithium raw material. The type of supplied inert gas is not particularly limited. For example, helium, neon, argon, nitrogen, and the like may be used.

In addition, the apparatus for preparing lithium sulfide according to one embodiment of the present invention may include a second inert gas supply unit 700 configured to supply an inert gas to the lithium sulfide recovery unit 400. Gases in the reaction chamber 100, such as hydrogen sulfide supplied into the reaction chamber 100 or water vapor generated as a by-product of the reaction, need to be discharged outside the reaction chamber 100 rather than flowing into the lithium sulfide recovery unit 400. The inert gas supplied into the lithium sulfide recovery unit 400 is discharged from the inside of the lithium sulfide recovery unit 400 to the outside through the lithium sulfide recovery line 30, so it is possible to prevent gas in the reaction chamber 100 from flowing into the lithium sulfide recovery unit 400.

At this time, the lithium sulfide recovery line 30 may be provided at a position facing an exhaust line 40, which will be described later. Therefore, it is possible to facilitate the gas in the reaction chamber 100 to be discharged into the exhaust line 40 by the inert gas. Meanwhile, the type of inert gas supplied from the second inert gas supply unit 700 is not particularly limited. For example, helium, neon, argon, nitrogen, and the like may be used.

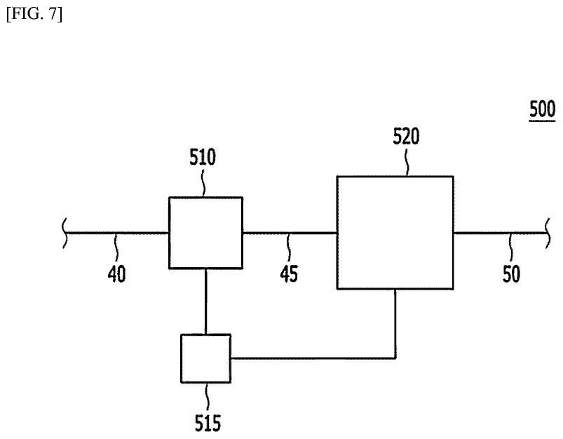

FIG. 7 is a schematic diagram showing a moisture removal unit according to one embodiment of the present invention. Hereinafter, referring to FIGS. 1 and 7, the moisture removal unit 500 according to one embodiment of the present invention will be described.

The moisture removal unit 500 is provided to recover the gas discharged from the reaction chamber 100, remove water vapor from the gas, and then re-supply the gas from which the water vapor has been removed to the upstream side of the reaction chamber 100. As described above, unreacted hydrogen sulfide that did not react with lithium hydroxide among the supplied hydrogen sulfide, and water vapor produced by the reaction of hydrogen sulfide and lithium hydroxide may be present within the reaction chamber 100. This unreacted hydrogen sulfide is supplied back to the upstream side of the reaction chamber 100 whereas the water vapor generated during the reaction needs to be removed. To this end, the moisture removal unit 500 may recover the gas in the reaction chamber 100 from the downstream side of the reaction chamber 100 through the exhaust line 40 and remove the water vapor to supply it to the upstream side of the reaction chamber 100. Meanwhile, a supply means such as a circulation pump (not shown) may be used to supply the hydrogen sulfide gas from which the water vapor has been removed into the reaction chamber.

Referring to FIG. 7, the moisture removal unit 500 may include a liquefaction cooling unit 510 and a sublimation cooling unit 520. The liquefaction cooling unit 510 may perform primary cooling of the gas recovered from the reaction chamber 100 and selectively remove only moisture from the recovered gas. For example, the liquefaction cooling unit 510 may be configured to liquefy water vapor by cooling the gas recovered through the exhaust line 40 to about 40° C., and the liquefied water may be removed through a discharge unit 515. The cooling structure of the liquefaction cooling unit 510 is not particularly limited, and may be, for example, a chamber provided with a cooling means (not shown).

Meanwhile, the sublimation cooling unit 520 may be configured to remove moisture by secondarily cooling the gas recovered from the reaction chamber 100. For example, water vapor may be removed by sublimation by cooling it to about −30° C. The sublimation cooling unit 520 may recover the gas that has passed through the liquefaction cooling unit 510 through a recovery line 45 and additionally remove water vapor that was not removed in the liquefaction cooling unit 510. Meanwhile, the terms “primary” and “secondary” used throughout this specification and claims should be understood as an arbitrarily assigned order for the purpose of distinction.

Meanwhile, primary cooling and secondary cooling do not mean the order of cooling, and the moisture removal unit 500 may include only the liquefaction cooling unit 510 or only the sublimation cooling unit 520, or both the liquefaction cooling unit 510 and the sublimation cooling unit 520 may be provided.

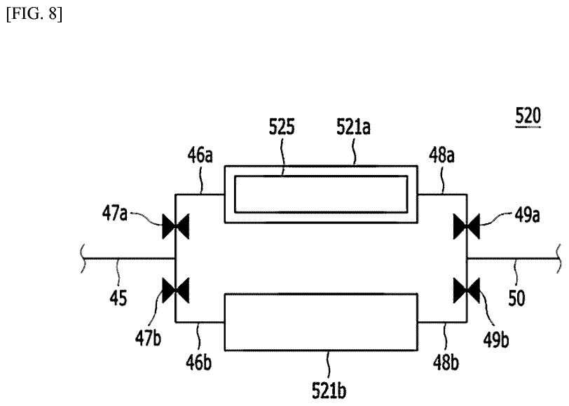

FIG. 8 is a perspective view showing a sublimation cooling unit according to one embodiment of the present invention. The sublimation cooling unit 520 may include a cooling chamber 521, a cooling means 525 provided in the cooling chamber 521, and a control unit (not shown) that controls the sublimation cooling unit 520. The control unit may be a control unit that controls the apparatus for preparing lithium sulfide.

The water vapor supplied to the cooling chamber 521 is sublimated by the cooling means 525 and frozen on the inner surface of the cooling chamber 521, and since hydrogen sulfide has a boiling point of −59.6° C., it can pass through the cooling chamber 521 as is. Therefore, the cooling chamber 521 may remove only water vapor from the recovered gas and supply hydrogen sulfide back to the reaction chamber 100.

However, since the sublimation cooling unit 520 sublimates water vapor, causing a phase transition to an ice state and freezing it on the inner surface of the cooling chamber, in order to remove moisture frozen on the inner surface of the cooling chamber 521, it is necessary to heat the cooling chamber 521 again to liquefy it. That is, when only one cooling chamber 521 is provided, the operation of the apparatus for preparing lithium sulfide should be stopped in order to heat the cooling chamber 521, making it difficult to continuously proceed with the process.

Therefore, the sublimation cooling unit 520 according to one embodiment of the present invention includes a plurality of cooling chambers 521a and 521b, a plurality of branch lines 46 for respectively transferring the recovered gas to the plurality of cooling chambers 521a and 521b, and a plurality of second branch lines 48 for supplying the gas in the plurality of cooling chambers 521 to a resupply line 50. The resupply line 50 refers to a line that allows the recovered gas to be resupplied to the reaction chamber 100. In addition, when the recovered gas is transferred to one preset cooling chamber among the plurality of cooling chambers 521, the control unit may control cooling to be performed in the cooling chamber to which the recovered gas is transferred.

First to fourth branch valves 47a, 47b, 49a, and 49b may be respectively provided in the branch lines 46a and 46b and the second branch lines 48a and 48b. The control unit may be configured to determine the cooling chamber 521a and 521b to which the recovered gas is transferred by controlling the branch valves 47a, 47b, 49a and 49b provided in the branch lines 46a and 46b and the second branch lines 48a and 48b. For example, in order to transfer the recovered gas to the cooling chamber 521a positioned at the upper side of FIG. 8, the first branch valve 47a and the third branch valve 49a may be opened, and the second branch valve 47b and the fourth branch valve 49b may be closed.

After the upper cooling chamber 521a to which the recovered gas is transferred is cooled for a predetermined period of time, it is necessary to heat and remove the ice frozen on the inner wall of the cooling chamber 521a by sublimation. In this case, after operating the cooling means (not shown) provided in the lower cooling chamber 521b so that the lower cooling chamber 521b performs cooling, the recovered gas may be controlled to be transferred to the lower cooling chamber 521b. That is, the first branch valve 47a and the third branch valve 49a are closed, and the second branch valve 47b and the fourth branch valve 49b are opened, so that the recovered gas can be controlled to be transferred to the lower cooling chamber 521b. Accordingly, not only may lithium sulfide be produced continuously without stopping the apparatus for preparing lithium sulfide, but also by additionally removing moisture from the recovered gas, lithium sulfide production efficiency may be improved and high purity lithium sulfide may be obtained.

Meanwhile, the control unit may liquefy and remove ice sublimated by cooling by switching the upper cooling chamber 521a that has been subjected to cooling for a predetermined period of time to heating. A separate heating means may be provided in the cooling chamber 521, and moisture may be removed simply by stopping the operation of the cooling means 525 and allowing the cooling chamber 521 to be at room temperature. The removed moisture may be transferred to the discharge unit 515 and removed.

In addition, instead of respectively providing the branch valves 47a, 47b, 49a, and 49b in the branch lines 46a, 46b, 48a, and 48b, a three-way valve (not shown) is provided at the branch points of the recovery line 45 and the branch line 46 and the branch point of the branch line 48 and the resupply line 50. The controller may control the three-way valve to determine the chamber to which the recovered gas is transferred.

In addition, the number of cooling chambers 521 is not particularly limited. When three or more cooling chambers 521 are provided, cooling may be performed simultaneously in multiple cooling chambers 521. The number of cooling chambers 521 may be appropriately provided depending on the amount of water vapor generated based on the size of the reaction chamber 100, the temperature at which the heating unit 150 heats the reaction space, etc.

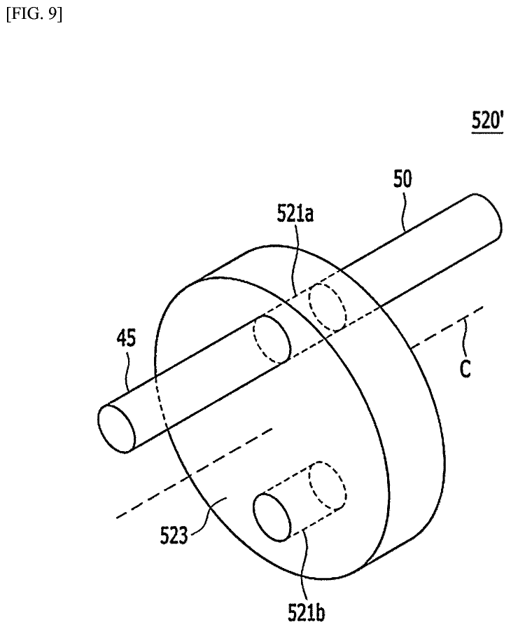

FIG. 9 is a perspective view showing a sublimation cooling unit according to another embodiment of the present invention. The sublimation cooling unit 520′ according to another embodiment of the present invention is different from the sublimation cooling unit 520 according to the above-described embodiment in that it has a main body 523 provided to be rotatable about an axis C parallel to the direction in which the recovered gas is transferred. In addition, a plurality of cooling chambers 521 may be formed to pass through the main body 523 along an axis C parallel to the direction in which the recovered gas is transferred. In addition, the sublimation cooling unit 520′ according to the present embodiment does not have a branch line 46, but may be provided so that at least one of the plurality of cooling chambers 521 is provided to communicate with the recovery line 45 and the resupply line 50.

That is, the control unit may control some of the plurality of cooling chambers 521 to perform cooling, and control the cooling chamber performing cooling to communicate with the recovery line 45 and the resupply line 50 by rotating the main body 523 about the axis C.

More specifically, when the cooling chamber 521a positioned on the upper side of FIG. 9 is cooled by a cooling means (not shown) while communicating with the recovery line 45 and the resupply line 50, as the recovered gas passes through the upper cooling chamber 521a, water vapor is sublimated and frozen inside the cooling chamber, thereby allowing it to be removed from the recovered gas. However, when the upper cooling chamber 521a where the recovered gas is transferred is cooled for a predetermined period of time and the space inside the cooling chamber becomes narrow and frozen ice needs to be removed, the control unit controls the lower cooling chamber 521b to perform cooling, and then may rotate the main body 523 about the axis C to change the cooling chamber 521 to which the recovered gas is transferred to the lower cooling chamber 521b. In addition, the control unit may liquefy and remove ice sublimated by cooling by switching the cooling chamber 521a that has been cooled for a predetermined period of time to be heated.

In the sublimation cooling unit 520′ according to this embodiment, since the cooling chamber 521 to which the recovered gas is transferred may be changed simply by rotating the main body 523 about the axis C, it is efficient because lithium sulfide can be produced continuously without stopping the apparatus for preparing lithium sulfide, and moisture may be more reliably removed to obtain high purity lithium sulfide.

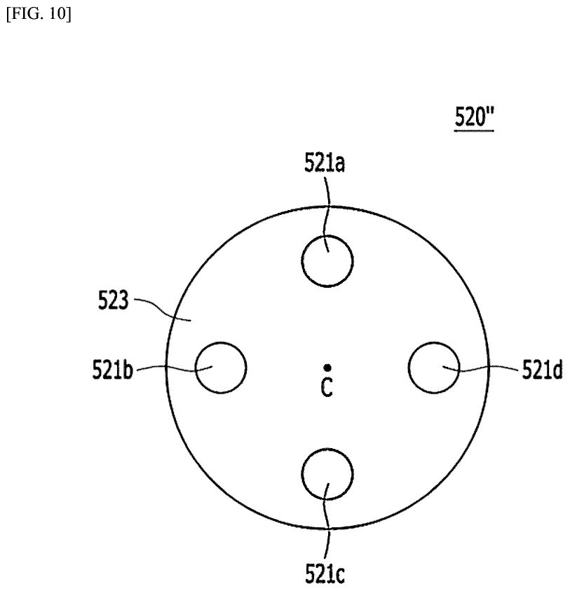

FIG. 10 is a front view showing a sublimation cooling unit according to still another embodiment of the present invention. The sublimation cooling unit 520″ according to this embodiment is different from the above-described sublimation cooling unit 520′ in that it is provided with three or more cooling chambers 521. The number of cooling chambers 521 is not particularly limited.

For example, when four cooling chambers 521a, 521b, 521c, and 521d are formed to pass through the main body 523 as shown in FIG. 10, at least one cooling chamber may be provided to communicate with the recovery line 45 and the resupply line 50. In addition, the control unit controls the plurality of cooling chambers 521a, 521b, 521c, and 521d to be sequentially cooled and also rotates the main body 523 about the axis C, and thus the recovered gas may be controlled to be transferred to the cooling chamber where cooling is in progress. Likewise, the cooling chamber that has been cooled for a predetermined period of time may be heated to liquefy and remove ice sublimated by cooling.

Alternatively, the sublimation cooling unit 520″ according to this embodiment may control cooling to proceed in a plurality of cooling chambers 521a and 521b, and in this case, a plurality of lines branched from the recovery line 45 may be provided to communicate with the plurality of cooling chambers 521a and 521b that perform cooling, respectively. The number of cooling chambers 521 may be appropriately provided depending on the amount of water vapor generated based on the size of the reaction chamber 100, the temperature at which the heating unit 150 heats the reaction space, etc.

In this way, the gas recovered from the reaction chamber 100 and from which moisture has been removed may be supplied again to the upstream side of the reaction chamber 100 through the resupply line 50 (see FIG. 1). The resupply line 50 may be connected to the upstream end of the reaction chamber 100. In addition, the resupply line 50 may be connected to the lower side of the reaction chamber 100. Since the lithium raw material supplied into the reaction chamber 100 will fall to the lower side of the reaction chamber 100 by gravity and then move, the hydrogen sulfide supplied through the resupply line 50 can secure sufficient reaction time with the lithium raw material.

Referring again to FIG. 1, the apparatus for preparing lithium sulfide according to one embodiment of the present invention may further include an inert gas discharge line 800. The inert gas discharge line 800 may be a discharge line for discharging inert gas within the reaction chamber 100. The inert gas discharge line 800 may be disposed upstream in the predetermined direction from the hydrogen sulfide supply location where the hydrogen sulfide supply unit 300 supplies hydrogen sulfide into the reaction chamber 100. That is, the inert gas discharge line 800 may be positioned upstream of the hydrogen sulfide supply line 20.

Therefore, the hydrogen sulfide supplied into the reaction chamber 100 will only partially react with the lithium raw material and then be supplied back to the upstream side of the reaction chamber 100 through the exhaust line 40 and the resupply line 50. The gas supplied through the resupply line 50 includes hydrogen sulfide from which moisture has been removed, most of the supplied hydrogen sulfide reacts with lithium raw materials while flowing with the inert gas to the inert gas discharge line 800, and the inert gas may be discharged through the inert gas discharge line 800. That is, the inert gas discharge line 800 may be in a form that suppresses the discharge of hydrogen sulfide and promotes only the discharge of the inert gas. To this end, the hydrogen sulfide supply line 20 may be positioned downstream from the center of the reaction chamber 100.

Additionally, a partition plate 120 may be installed within the reaction chamber 100. The partition plate 120 may have a flat plate shape extending along a direction crossing the predetermined direction. The partition plate 120 is installed between the hydrogen sulfide supply position and the inert gas discharge line 800 to prevent hydrogen sulfide supplied through the hydrogen sulfide supply line 20 from being discharged directly to the inert gas discharge line 800.

In addition, the partition plate 120 may be provided on an upper side of the reaction chamber adjacent to the inert gas discharge line 800, and may be provided on an inner side of the reaction chamber 100 to provide a space for fluid to flow. Therefore, it is possible to prevent the inert gas from passing through the inert gas discharge line 800 and flowing directly into the exhaust line 40.

The above description is merely an illustrative explanation of the technical idea of the present invention, and various modifications and variations will be apparent to those skilled in the art without departing from the essential characteristics of the present invention. Therefore, the embodiments disclosed in the present invention are not intended to limit the technical idea of the present invention, but are for illustrative purposes, and the scope of the technical idea of the present invention is not limited by these embodiments. The scope of protection of the present invention should be interpreted in accordance with the claims below, and all technical ideas within the equivalent scope should be construed as being included in the scope of rights of the present invention.

### REFERENCE NUMBERS IN THE DRAWINGS

10: Lithium raw material supply line
20: Hydrogen sulfide supply line
30: Lithium sulfide recovery line
40: Discharge line
45: Recovery line
46 (46a, 46b): Branch line
47 (47a, 47b): Branch valve
48 (48a, 48b): Branch line
49 (49a, 49b): Branch valve
50: Resupply line
60: Inert gas supply line
100: Reaction chamber
120: Partition plate
150: Heating unit
200: Lithium raw material supply unit
300: Hydrogen sulfide supply unit (hydrogen sulfide reactor)
301: Hydrogen sulfide reaction chamber
301a: Hydrogen sulfide outlet
302: Liquid sulfur supply pipe
303: Liquid sulfur heating device
304: Liquid sulfur spray pipe
304a: Liquid sulfur spray nozzle
304b: Pump
305: Hydrogen gas supply pipe
306: Discharge pipe
308: Condenser
309: Discharge pipe
310: Cover plate
320: First partition wall member
321: Plate
322: First outer wall
325: First flange
330: Second partition wall member
331: Second outer wall
335: Second flange
350: Flow path forming plate
400: Lithium sulfide recovery unit
500: Moisture removal unit
510: Liquefaction cooling unit
515: Discharge unit
520, 520′, 520″: Sublimation cooling unit
521 (521a, 521b, 521c, 521d): Cooling chamber
523: Main body
525: Cooling means
600: Inert gas supply unit
700: Second inert gas supply unit
800: Inert gas discharge line
P1: First flow path
P2: Second flow path

What is claimed is:

1. An apparatus for preparing lithium sulfide, comprising:
a reaction chamber that has a reaction space for generating lithium sulfide and is provided to move a supplied lithium raw material in a predetermined direction;
a lithium raw material supply unit provided to continuously supply the lithium raw material to an upstream side of the reaction chamber in the predetermined direction;
a hydrogen sulfide supply unit provided to supply hydrogen sulfide to the reaction chamber;
a heating unit provided to heat the reaction space;
a lithium sulfide recovery unit provided on a downstream side of the reaction chamber in the predetermined direction and provided to recover lithium sulfide that is generated by a reaction between the hydrogen sulfide and the lithium raw material in the reaction chamber;
an inert gas supply unit provided to supply an inert gas to the upstream side of the reaction chamber in the predetermined direction; and
a moisture removal unit provided on the downstream side of the reaction chamber in the predetermined direction to recover gas discharged from the reaction chamber, remove water vapor from the gas, and then supply the gas back to the upstream side of the reaction chamber in the predetermined direction,
wherein the hydrogen sulfide supply unit is a hydrogen sulfide reactor that synthesizes hydrogen sulfide by using liquid sulfur that is sprayed from a liquid sulfur spray pipe and hydrogen gas.

2. The apparatus of claim 1, wherein the moisture removal unit includes a liquefaction cooling unit that primarily cools the gas recovered from the reaction chamber and selectively removes only moisture from the gas.

3. The apparatus of claim 1, wherein the moisture removal unit includes a sublimation cooling unit that secondarily cools the gas recovered from the reaction chamber and selectively removes only moisture from the gas.

4. The apparatus of claim 3, wherein
the sublimation cooling unit includes a plurality of cooling chambers and a control unit that controls the sublimation cooling units, and
when the recovered gas is transferred to one or more preset cooling chambers among the plurality of cooling chambers, the control unit controls secondary cooling to be performed in the cooling chamber to which the recovered gas is transferred.

5. The apparatus of claim 4, wherein, after the cooling chamber to which the recovered gas is transferred is cooled for a predetermined period of time, the control unit controls the recovered gas to be transferred to another cooling chamber, and the cooling chamber that has been cooled for the predetermined period of time is heated to liquefy and remove ice sublimated by cooling.

6. The apparatus of claim 5, wherein
the sublimation cooling unit includes a plurality of branch lines for transferring the recovered gas to the plurality of cooling chambers, and a valve installed in the branch lines to open and close each branch line, and
the control unit is configured to determine the cooling chamber to which the recovered gas is transferred by controlling the valves.

7. The apparatus of claim 5, wherein
the sublimation cooling unit has a main body provided to be rotatable about an axis parallel to the direction in which the recovered gas is transferred,
the plurality of cooling chambers are formed to pass through the main body along a direction parallel to the axis, and at least one cooling chamber is provided to communicate with a recovery line, which is a line through which the recovered gas is transferred, and a resupply line to allow the recovered gas to be resupplied to the reaction chamber, and
the control unit controls the cooling chamber performing cooling to communicate with the recovery line and the resupply line by rotating the main body about the axis.

8. The apparatus of claim 7, wherein, after the cooling chamber to which the recovered gas is transferred is cooled for a predetermined period of time, the control unit rotates the main body about the axis to control the recovery line to communicate with another cooling chamber scheduled for a cooling operation, and the cooling chamber that has been cooled for the predetermined period of time is heated to liquefy and remove ice sublimated by cooling.

9. The apparatus of claim 1, further comprising an inert gas discharge line connected to the reaction chamber for discharging the inert gas in the reaction chamber,
wherein the inert gas discharge line is disposed upstream in the predetermined direction from a hydrogen sulfide supply location where the hydrogen sulfide supply unit supplies hydrogen sulfide into the reaction chamber.

10. The apparatus of claim 9, further comprising a partition plate installed in the reaction chamber and extending along a direction crossing the predetermined direction,
wherein the partition plate is installed between the hydrogen sulfide supply location and the inert gas discharge line.

11. The apparatus of claim 10, wherein the partition plate is provided on an upper side of the reaction chamber adjacent to the inert gas discharge line, and is provided on an inner side of the reaction chamber to provide a space for fluid to flow.

12. The apparatus of claim 1, wherein the hydrogen sulfide reactor includes:
a hydrogen sulfide reaction chamber having a hollow hydrogen sulfide reaction space and a hydrogen sulfide outlet for discharging hydrogen sulfide synthesized in the hydrogen sulfide reaction space;
the liquid sulfur spray pipe configured to recover liquid sulfur accommodated in the hydrogen sulfide reaction chamber and spray the recovered liquid sulfur into the hydrogen sulfide reaction space;
a liquid sulfur heating device configured to heat the liquid sulfur;
a hydrogen gas supply pipe configured to supply hydrogen gas to the hydrogen sulfide reaction space below a position where the liquid sulfur is sprayed from the liquid sulfur spray pipe; and
a flow path change member that changes a flow path to be longer than a straight path so that hydrogen gas, sulfur gas generated by vaporizing the liquid sulfur, and hydrogen sulfide synthesized by the reaction of the hydrogen gas and the sulfur gas do not flow in the straight path toward the hydrogen sulfide outlet.

13. The apparatus of claim 12, wherein
the flow path change member includes a plate extending along a direction crossing the straight path and a first partition wall member having a first outer wall extending from the plate to form a space in which the liquid sulfur and the hydrogen gas are supplied; and
the first partition wall member is disposed to be spaced apart from the hydrogen sulfide reaction chamber so that a first flow path is formed between an outer surface of the first outer wall and an inner surface of the hydrogen sulfide reaction chamber.

14. The apparatus of claim 13, wherein
the flow path change member further includes a second partition wall member having a second outer wall formed in a pillar shape with both sides open,
the liquid sulfur and the hydrogen gas are supplied to an inner space of the second outer wall, and
the second partition wall member is disposed to be spaced apart from the first partition wall member so that a second flow path is formed between the second partition wall member and the first partition wall member.

15. The apparatus of claim 12, wherein
the flow path change member includes at least one flow path forming plate extending along a direction crossing the straight path, and
the flow path forming plate has one end coupled to an inner surface of the hydrogen sulfide reaction chamber, and the other end extending to be spaced apart from the inner surface of the hydrogen sulfide reaction chamber to form a space for fluid to flow between the other end and the inner surface of the hydrogen sulfide reaction chamber.
